(19) United States
(12) Patent Application Publication
(10) Pub. No.: US 2009/0094165 A1
(43) Pub. Date: Apr. 9, 2009

(54) Global media exchange marketplace for media contents

(75) Inventors: Jose A. Royo, Venice, CA (US); Richard S. Maraschi, Santa Monica, CA (US); William E. Niles, Malibu, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Ascent Media Group, Inc.

(21) Appl. No.: 11/906,957

(22) Filed: Oct. 3, 2007

(51) Int. Cl. G06Q 10/00; G06F 17/30

(52) U.S. Cl. 705/80; 705/1; 705/28

(57) ABSTRACT

An embodiment of the present invention is an on-line global media exchange (GMX) marketplace. The GMX marketplace manages media content participants. The participants include a first party and a second party. The first and second parties include at least one of a content owner, a buyer, an advertiser, and a third-party service provider. A transaction among the participants is executed via the on-line GMX marketplace. The transaction is customized according to, and negotiated between, the first and second parties.

### BACKGROUND

1. Field of the Invention

Embodiments of the invention relate to the field of media commercial transactions, and more specifically, to global media exchange marketplace for media contents.

2. Description of Related Art

Commercial transactions for media contents such as films, movies, video, and feature programs, have become increasingly popular. These transactions typically involve media distribution, selling and buying negotiation, content licensing, etc. Traditional methods for such commercial transactions usually involve organization of film festivals, conferences, and markets or private meetings with interested parties (e.g., distributors, agents, producers). These methods are inefficient and expensive. Many of the interested parties are small or independent producers and distributors. They may not be able to afford attending film festivals or media content conferences.

On-line marketplaces may provide market participation at a lower cost and convenience. However, these marketplaces typically involve an open or transparent auction model that may not be suitable for media contents, especially in the film or motion picture industry. In addition, these marketplaces merely act as a selling and buying point without any added-value services such as customized transactions, post-sales, imaging, vault, and distribution services.

### BRIEF DESCRIPTION OF THE DRAWINGS

Embodiments of invention may best be understood by referring to the following description and accompanying drawings that are used to illustrate embodiments of the invention. In the drawings:

FIG. 1 is a diagram illustrating a system according to one embodiment of the invention.

FIG. 2 is a diagram illustrating a marketplace according to one embodiment of the invention.

FIG. 3 is a diagram illustrating a user interface module according to one embodiment of the invention.

FIG. 4 is a diagram illustrating a participant manager according to one embodiment of the invention.

FIG. 5 is a diagram illustrating a transaction manager according to one embodiment of the invention.

FIG. 6 is a diagram illustrating an execution engine according to one embodiment of the invention.

FIG. 7 is a diagram illustrating participant views in the marketplace according to one embodiment of the invention.

FIG. 8 is a diagram illustrating a cash deal transaction according to one embodiment of the invention.

FIG. 9 is a diagram illustrating an advertisement transaction according to one embodiment of the invention.

FIG. 10 is a diagram illustrating a revenue share transaction according to one embodiment of the invention.

FIG. 11 is a flowchart illustrating a process to operate the marketplace according to one embodiment of the invention.

FIG. 12 is a flowchart illustrating a process to manage participants according to one embodiment of the invention.

FIG. 13 is a flowchart illustrating a process to execute a transaction according to one embodiment of the invention.

FIG. 14 is a flowchart illustrating a process to enable first party to initiate a deal according to one embodiment of the invention.

FIG. 15 is a flowchart illustrating a process to enable a negotiation according to one embodiment of the invention.

FIG. 16 is a diagram illustrating a server to according to one embodiment of the invention.

### DESCRIPTION

An embodiment of the present invention is an on-line global media exchange (GMX) marketplace. The GMX marketplace manages media content participants. The participants include a first party and a second party. The first and second parties include at least one of a content owner, a buyer, an advertiser, and a third-party service provider. A transaction among the participants is executed via the on-line GMX marketplace. The transaction is customized according to, and negotiated between, the first and second parties.

In one embodiment, the GMX marketplace includes a user interface module, a participant manager, a transaction manager, and a portal engine. The user interface module interfaces with media content participants. The participant manager manages the participants. The transaction manager executes a transaction between the first and second parties. The portal engine provides a centralized access point for the GMX marketplace

In the following description, numerous specific details are set forth. However, it is understood that embodiments of the invention may be practiced without these specific details. In other instances, well-known circuits, structures, and techniques have not been shown to avoid obscuring the understanding of this description.

One embodiment of the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc.

One embodiment of the invention is a technique to provide an efficient and cost-effective on-line GMX marketplace for media contents. The media contents may include filmed entertainment media contents (e.g., full feature films, episodic television programs, short films, documentary films), multimedia assets, films, audio-visual materials, videos and/or audio files, program features, or packaged media files, etc. The GMX marketplace is in essence a Web site that provides individualized and/or customized services to sellers, buyers, advertisers, or third-party service providers in transactions involving media contents. The marketplace participants may be any interested parties of any size, large or small, including well-established media companies, individual producers or buyers, or any other business entities. The GMX marketplace may provide a one-stop, integrated, and customized point to facilitate and/or enhance deal transactions. It may create, supplement, or replace existing sales and acquisition methods that are inefficient and more costly then necessary. It may complement traditional post services, digital imaging services, digital vault services, and digital distribution services. Additionally, it may provide many benefits and business opportunities such as increased shelf space, capability to target audiences for advertisers, creating a need for a larger quantity of more focused programming, and capitalizing on new business opportunities and/or creating efficiencies or cost savings in areas such as connecting buyers and sellers via marketing and search tools, deal execution and management (via templates, reporting, and tracking tools, etc.), and fulfillment of executed deals (e.g., integrated packaging, formatting, and physical/digital distribution). Drivers of shelf space are the proliferation of digital media channels on various platforms such as digital terrestrial, digital cable/satellite, Internet protocol television (IPTV), mobile, and broadband Internet/video portals.

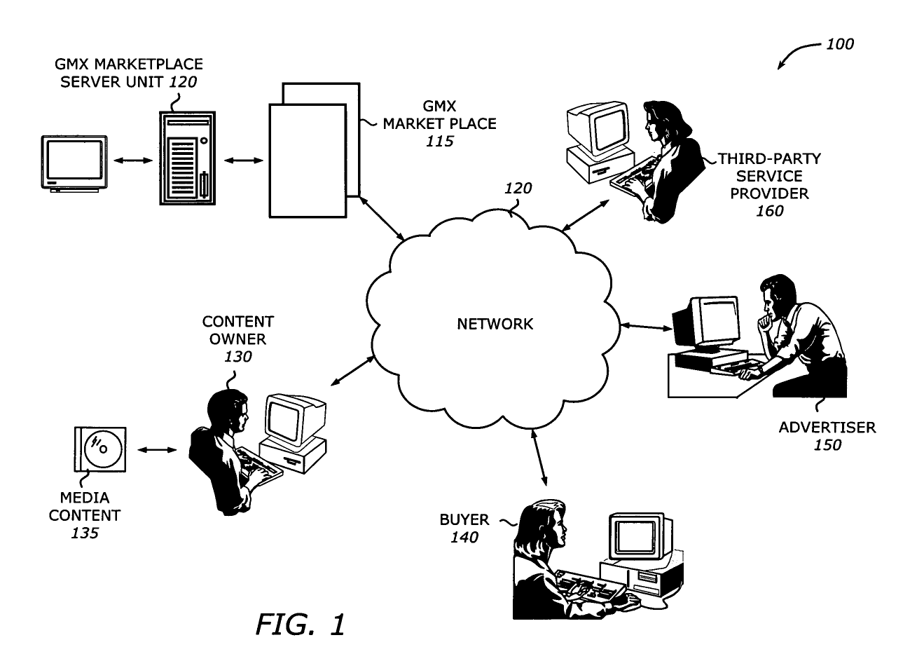

FIG. 1 is a diagram illustrating a system 100 according to one embodiment of the invention. The system 100 includes a GMX marketplace server unit 110, a network 120, a content owner 130, a buyer 140, an advertiser 150, and a third-party service provider 160. It is noted that the system 100 may include more or less than the above components. Furthermore, for illustrative purposes, only one for each of the content owner 130, the buyer 140, the advertiser 150, and the third-party service provider 160 is shown. It is contemplated that there may be multiple content owners, buyers, advertisers, and third-party service providers.

The server unit 110 is a server powered to support a GMX marketplace 115. The GMX marketplace 115 is in essence a package to operate a Website having an integrated environment to allow marketplace participants to participate in exchange transactions or deals involving media contents. The server unit 110 provides user interface, database, services management, inventory management, participant management, transaction management, and services that are needed to enable negotiations among the participants. It is connected to the network 120 via an appropriate network interface.

The network 120 may be any network to provide connectivity to the server unit 110 and marketplace participants. It may be wired or wireless. In one embodiment, it is the Internet. It is noted that any type of networks may be employed such as intranet, extranet, Wireless Fidelity (Wi-Fi), Wide Area Network (WAN), Local Area Network (LAN), power line, etc. In one embodiment, the transmission on the network 120 is a secured transmission with security features such as digital certificates, digital signature, watermarking, encryption/decryption, or any other tamper-proof features.

The content owner 130 may be an individual, a content provider, a distributor, a sales agent, a syndication company, a media producer, an organization, a business, or any entity who owns the right to sell, negotiate, or add value to media contents 135 that are uploaded to the marketplace 115. The content owner 130 participates in the marketplace 115 to find buyers or look for business opportunities to enhance the products. The content owner 130 may sell, license, or transfer the right or ownership of the content, the content into a specific distribution channel, an access into a distribution channel, an advertising space against the content, a sponsorship, a new packaged content for syndication, or any transaction that may bring in revenues or enhance the media contents 135. The content owner 130 may also buy, obtain license, or receive the right or ownership of services, support to the marketplace participants, brokerage the content exchanges, or any other products or services related to the media contents. The content owner 130, therefore, may play the role of a seller or a buyer.

The media contents 135 owned by the content owner 130 may be any media contents. They may include filmed entertainment media contents (e.g., full feature films, episodic television programs, short films, documentary films), multimedia assets, films, audio-visual materials, video and/or audio files, program features, or packaged media files, etc. In one embodiment, the marketplace may be geared toward only to the filmed entertainment media contents. The media contents 135 may be uploaded to the marketplace 115 or the server unit 110 via the network 120 for storage and maintained. The media contents 135 may also be transferred to the server unit 110 by any suitable delivery methods, including satellite transmission, and physical delivery via physical media such as digital versatile disk (DVD), compact disk read only memory (CD-ROM). The media contents 135 may include security features for verification, authentication, digital rights/restriction management (DRM), copyright protection, digital watermarking, etc.

The buyer 140 may be any entity that is interested in buying, or obtaining license for, the media contents 135 owned by the content owner 130. The buyer 140 may be an individual, a business, an organization, or even a content owner.

The advertiser 150 may be an advertisement agent, a sales representative, a manufacturer, a service provider, or any entity that wants to buy an advertisement space on the media contents. The advertiser 150 may want to negotiate advertisement terms based on a time slot, duration, location, or the type of media contents.

The third-party service provider 160 may be any individual, business, organization, or entity who wants to provide services supplementary or ancillary to the transactions on the marketplace. Examples of these services may be payment services (e.g., credit payment, bank transfer), verification, authentication, brokerage, and various media management and fulfillment services, etc.

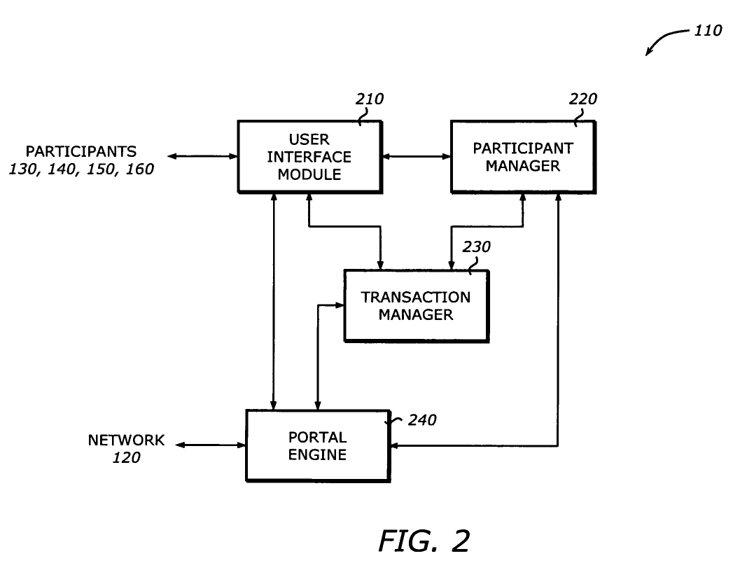

FIG. 2 is a diagram illustrating the marketplace 115 shown in FIG. 1 according to one embodiment of the invention. The marketplace 115 includes a user interface module 210, a participant manager 220, a transaction manager 230, and a portal engine 240. It is noted that the marketplace 115 may include more or less than the above components. In addition, any of the components of the marketplace 115 may be implemented by hardware, software, firmware, or a combination of any of them.

The user interface module 210 interfaces with media content participants so that the participants may participate in exchange activities or transactions on the marketplace. The participants may include a first party and a second party who may be involved in a transaction. The first and second parties may include at least one of the content owner 130, the buyer 140, the advertiser 150, and the third-party service provider 160, shown in FIG. 1. Typically, one of the first and second parties is the content owner 130 whose media content is an item of interest in the transaction.

The participant manager 220 manages the media content participants so that their participation in the exchange activities or transactions may be as effective and convenient as possible. The participant manager 220 may also provide security and/or protection features to ensure that the transactions or deals that are executed on the exchange to be as secure, protected, and confidential as possible.

The transaction manager 230 executes a transaction between the first and second parties from the participants. The transaction manager 230 is typically interfaced to the user interface module 210 and the participant manager 220 to share or communicate information, data, and results related to the transaction.

The portal engine 240 provides a centralized access point for the GMX marketplace. The portal engine 240 is interfaced to the user interface module 210 to provide a consistent presentation format, an efficient look-and-feel interface, an integrated accessibility to various databases or modules within the marketplace, and other functionalities that enhances the user interactions and information gathering and presentation.

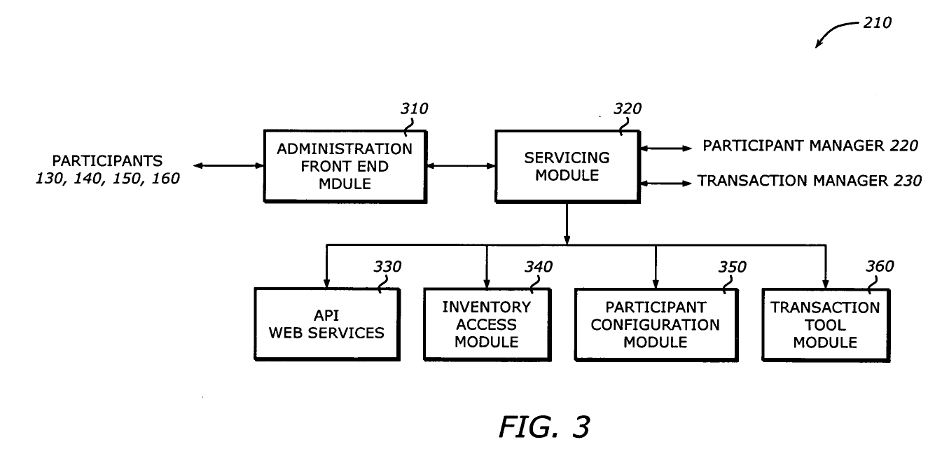

FIG. 3 is a diagram illustrating the user interface module 210 shown in FIG. 2 according to one embodiment of the invention. The user interface module 210 includes an administration front end module 310 and a services module 320. It is noted that the user interface module 210 may include more or less than the above components.

The administration front end module 310 administers interactions between the GMX marketplace and the participants. This may include management of log-in sessions, registration of participants, creating profiles, etc. It may include security and protection features such as the use of passwords, personal identification numbers (PINs), biometrics (e.g., iris scans, fingerprints), digital signatures, encryption/decryption, public/private key generation, or any combination of these security features. It may also include a control and access tool to allow participants to have flexibility in accessing the targets such as the ability to do a one-to-one, one-to-many, or one-to-group transaction. A group may be formed by defining the access criteria for target participants.

The services module 320 provides on-line services to the participants. The services module 320 includes at least one of an application programming interface (API) 330, an inventory access module 340, a participant configuration module 350, and a transaction tool module 360.

The API 330 provides an interface to an application that provides the Web services. The application may be any suitable application including a Web browser application, a communication application, etc. The inventory access module 340 provides access to the various inventories of media contents. The access actions or functions provided by the inventory access module 340 may include a search action, a preview action, and a select action. The search action searches for media contents that meet some specified search criteria. The preview action previews the media content perhaps by showing a clip, or displaying the metadata or description associated with a selected content. The select action selects a media content from the inventory. The participant configuration module 350 registers, configures, or sets up a participant. The configuration module 350 may assign user identifier, password protection, and account allocation; generate participant profile according to some pre-defined format; configure upload/download parameters (e.g., bandwidth, resolution, size) for uploading/downloading media contents; and allocate storage to each participant. The transaction tool module 360 may provide various tools to manage or execute a transaction and participants' content information. Examples of these tools may include an editing tool to create a deal proposal; an authentication tool to authenticate the identity of the participants, the media contents, and the transaction or deal documents; and a security tool to provide security and protection to communication among the participants, between the exchange and the participants, and access control. For example, digital watermarks may be employed by the exchange or the participants to verify that the media content is genuine, or to verify that the content has not been altered or falsified. Encryption and decryption may be employed to ensure security of confidential communication. The transaction tool module 360 may also include marketing and acquisition tools, marketing and/or business intelligence tools to allow participants to perform market analysis and content acquisition strategies and techniques, business prediction, and other related methods.

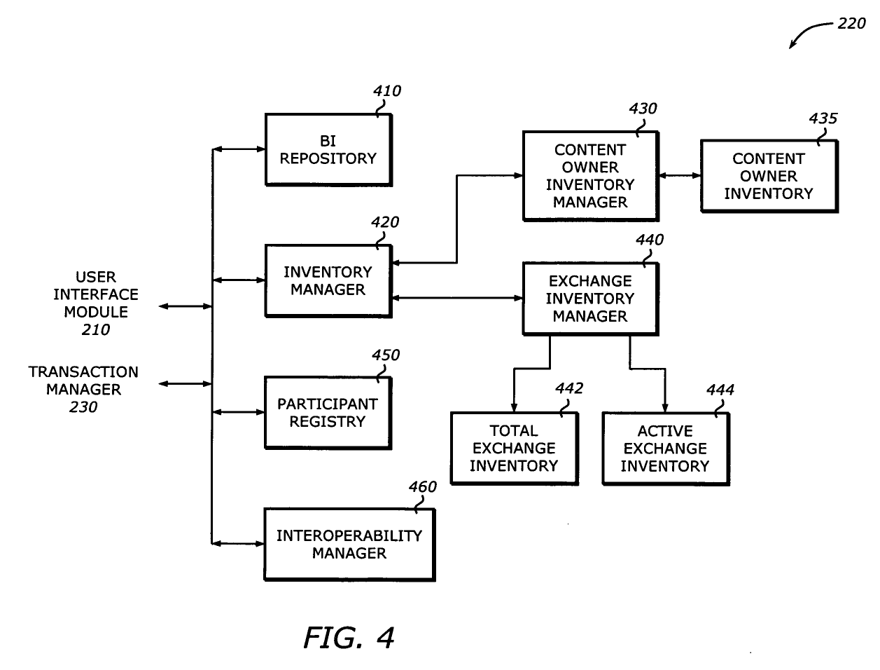

FIG. 4 is a diagram illustrating the participant manager 220 shown in FIG. 2 according to one embodiment of the invention. The participant manager 220 includes a business intelligence (BI) repository 410, an inventory manager 420, a participant registry 450, and an interoperability manager 460. It is noted that the participant manager 220 may include more or less than the above components.

The BI repository 410 stores business information regarding the participants. It may include analyzed data, metrics, statistical data, trend information, or any information that may be useful for the operations of media content business.

The inventory manager 420 manages inventories of media contents. It may include a content owner inventory manager 430 to manage a content owner inventory 435 of a content owner, and an exchange inventory manager 440 to manage exchange inventories. The content owner inventory 435 is the inventory of the media contents uploaded by a content owner. The content owner inventory manager 430 allows a content owner 130 to edit, upload, updates, delete, etc. his media contents. The content owner 130 may apply any security or authentication features to the media contents using the transaction tool module 360 (FIG. 3). The exchange inventories may include a total exchange inventory 442 and an active exchange inventory 444. The total exchange inventory 442 includes all the media contents uploaded by all the registered content owners. The active exchange inventory 444 includes the media contents that are active and available for an exchange transaction. The exchange inventory manager 440 maintains, updates, transfers, deletes, etc. the total exchange inventory 442 and the active exchange inventory 444. The inventories may be implemented by a database or a repository and may include identification of the media contents, content metadata, rights associated with the media contents, and preferred target participants.

The participant registry 450 maintains registration information on the participants. The registry 450 may include registration and directory services. It may allow a participant to register having a role as a content owner, buyer, advertiser, or third-party service provider. A participant may register for one or more roles. When a participant registers to the marketplace, he or she may also create his or her profile. The profile may include useful information about the participant. For example, the profile may include a list of preferred types of media contents, geographical location, preferred target participants (e.g., authorized buyers, preferred content owners, preferred types of media contents, preferred types of advertisements). The participant registry 450 may employ security and protection tools provided by, or similar to, the transaction tool module 360 shown in FIG. 3. It may also include a criteria tool to generate criteria to select participants such as criteria requiring the sellers to meet certain professional standards to ensure that the media contents are produced with high quality and professionalism. The criteria tool may interface with the business intelligence engine to obtain BI information in selecting appropriate participants in a marketplace transaction. This may also help in identifying, qualifying, and connecting buyers and sellers.

The interoperability manager 460 maintains interoperability among the participants. It ensures that information, data, or objects such as participant profile, preferences, and inventories follow some specified standards or formats. For example, eXtensible Markup Language (XML) with a common vocabulary (e.g., schema) may be used.

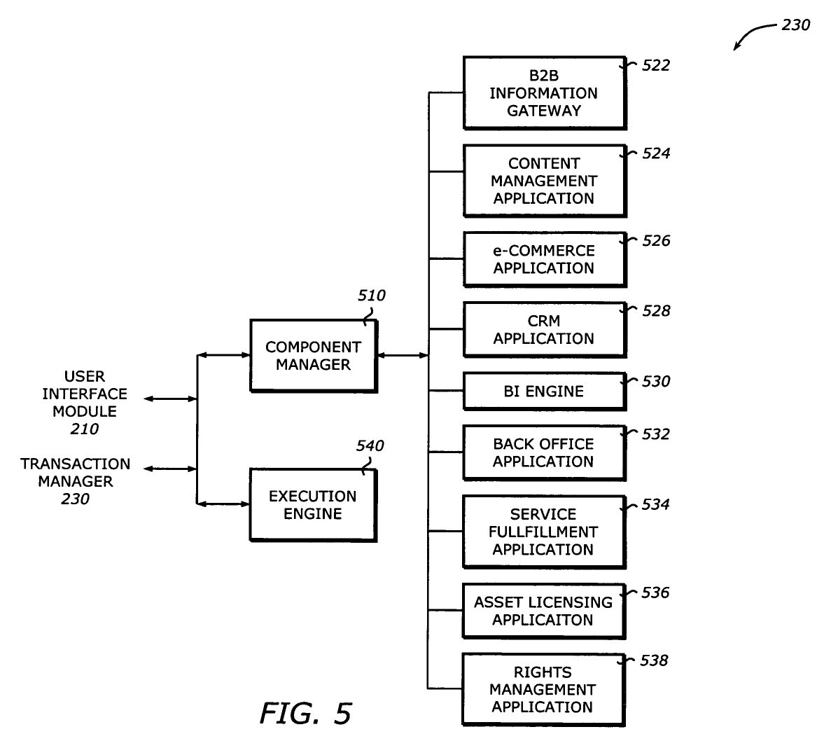

FIG. 5 is a diagram illustrating the transaction manager 230 shown in FIG. 2 according to one embodiment of the invention. The transaction manager 230 includes a component manager 510 and an execution engine 540. It is noted that the transaction manager 230 may include more or less than the above components.

The component manager 510 manages a component of the GMX marketplace. It may include a number of applications that are used to operate the marketplace. These applications may include a business-to-business (B2B) information gateway 522, a content management application 524, an electronic commerce (e-Commerce) application 526, a customer relationship management (CRM) application 528, a BI engine 530 to perform BI operations using the BI repository 410 (FIG. 4), a back office application 532 to perform various back office tasks such as billing, financial report generation, a services fulfillment application 534, an asset licensing application 536, and a rights management application 538.

The execution engine 540 enables and fulfills the transactions taken place on the marketplace. In general, a transaction is an activity that involves two parties: a first party and a second party. The first party may be a party that makes an offer. The second party may be a party that receives the offer and responds to the offer. The execution engine enables the first party to initiate a deal to the second party and enables a negotiation of the deal between the first and second parties. The first and the second parties may be any registered participants in the marketplace. For example, in one transaction, the first party may be a buyer and the second party may be a content owner. In another transaction, the first party may be a content owner and the second party may be a buyer. The transactions taken place on the exchange are customized according to, and negotiated between, the first and second parties.

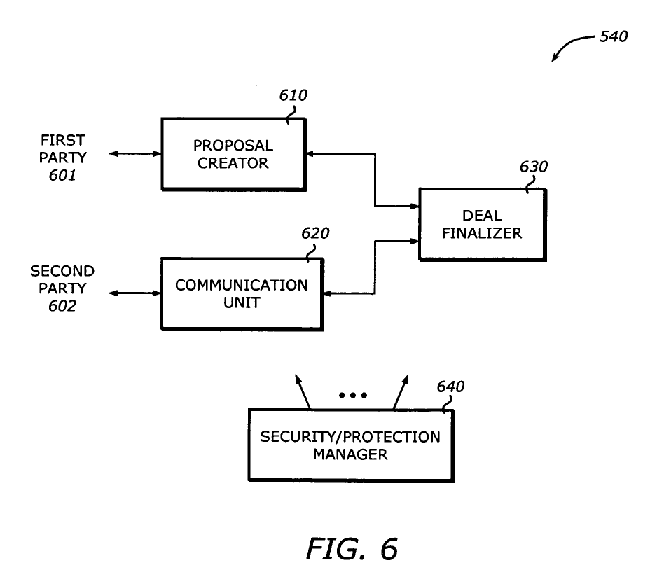

FIG. 6 is a diagram illustrating the execution engine 540 shown in FIG. 5 according to one embodiment of the invention. The execution engine 540 includes a proposal creator 610, a communication unit 620 and deal finalizer 630. It is noted that the execution engine 540 may include more or less than the above components.

The proposal creator 610 creates a deal proposal based on an offer submitted by the first party. The offer may be one of a cash offer, an advertising bid, and a revenue share bid. The proposal creator 610 incorporates licensing profile into the deal proposal when the offer is the cash offer or the revenue share bid. The proposal creator 610 may employ the tools provided by the transaction tool module 360 (FIG. 3). The deal proposal is tailored or customized according to the specifications or requirements by the first party. This may be performed automatically, manually, or a combination of automated and manual methods using the profile of the first party or the information obtained from the BI repository 410 (FIG. 4) or provided by the BI engine 530 (FIG. 5).

The communication unit 620 notifies the parties of a proposal or a response, or forwards the deal proposal to the second party and forwards a response from the second party to the first party. The response from the second party may be one of an offer acceptance, an offer rejection, and an offer modification. An offer modification may represent a counter-offer from the second party, or a negotiated deal terms. The communication unit 620 may include security features provided by the transaction tool module 360 (FIG. 3) such as encryption/decryption, digital signatures, digital watermarking, etc.

The deal finalizer 630 finalizes the deal with transaction terms. The transaction terms may include any terms as part of the negotiation or the offer. They may include price, item to be delivered, delivery time, licensing terms, and any other terms that are agreed to by the two parties. The deal finalizer 630 may also generate an entitlement according to the transaction terms. The entitlement may be any right or benefit that is granted or given to the exchange/marketplace owner as a compensation for providing the marketplace services. This may include a commission, a subscription, a flat fee, or any other suitable financial or commercial agreement.

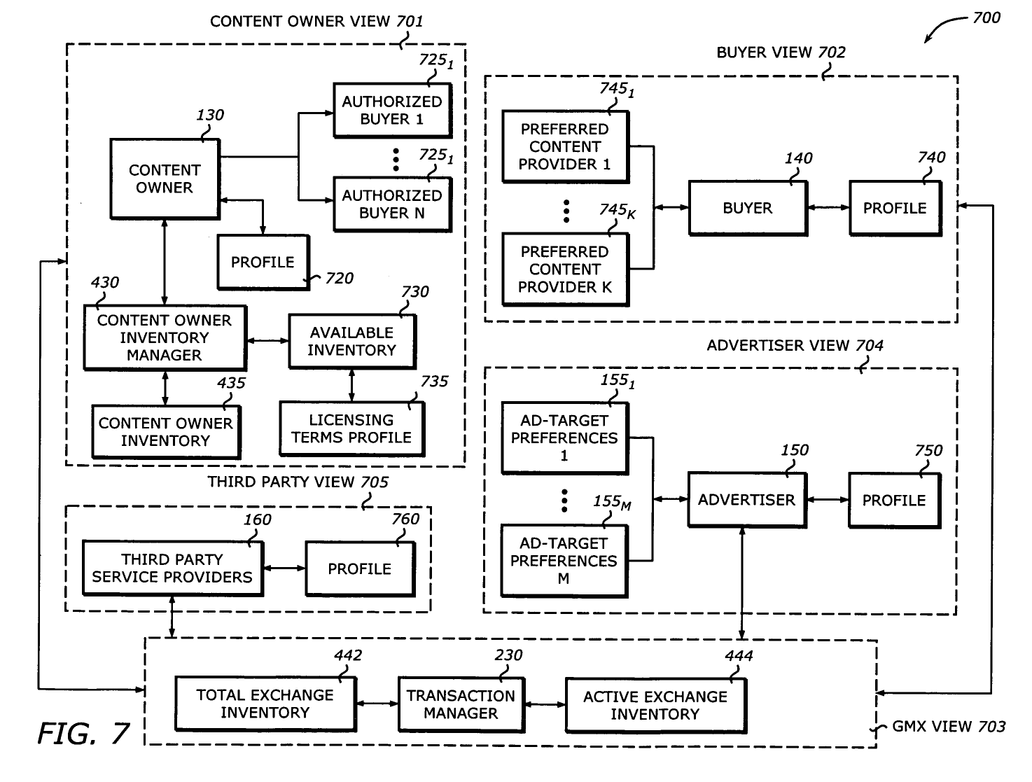

FIG. 7 is a diagram illustrating participant views 700 in the marketplace according to one embodiment of the invention. The participant views 700 include a content owner view 701, a buyer view 702, a GMX view 703, an advertiser view 704, and a third-party view 705. The participant views 700 show the elements involved in typical scenarios of registration and exchange transactions.

The content owner view 701 shows the components associated with the content owner 130. The content owner 130 manages a list of authorized buyers 725₁ to 725_{N}. The content owner 130 creates a profile 720 during registration. The content owner 130 invokes the content owner inventory manager 430 to manage the content owner inventory 435 and generate an available inventory 730. The available inventory 730 includes media contents that are available for the exchange transactions. A licensing terms profile 735 includes licensing information of the media contents in the available inventory 730.

The buyer view 702 shows the components associated with the buyer 702. The buyer 140 manages a list of preferred content providers 745₁ to 745_{K}. These content providers are the content owners or providers that the buyer 140 preferably deals with. Additional classifications may be provided such as favorites, ratings/reputation, most/least, based on various parameters. The buyer 140 creates a profile 740 during registration.

The GMX view 703 shows the components associated with the exchange. It includes the transaction manager 230 (FIG. 2), the total exchange inventory 442 and the active exchange inventory 444 (FIG. 4).

The advertiser view 704 shows the components associated with the advertiser 150. The advertiser 150 manages a list of advertiser target preferences 155₁ to 155_{M}. The advertiser 150 creates a profile 750 during registration.

The third-party view 705 shows the components associated with the third-party service provider 160. The third-party service provider 160 creates a profile 760 during registration.

The transactions or deals that are executed on the exchange may be any transactions that are agreed to by the parties involved. They may include a cash deal, a barter deal, and a blend deal. The cash deal is a deal with cash payment for a given set of terms or conditions, showings, etc. The barter deal is a revenue sharing deal which pays a percentage of the revenue (e.g., percentage of ticket receipts). It may also include advertising spot sharing. The blend deal is a combination of the cash deal and the barter deal. For example, it may include an initial cash payment for a license fee and subsequent payments based on percentage of receipts, advertising revenue, or advertisement spots to sell.

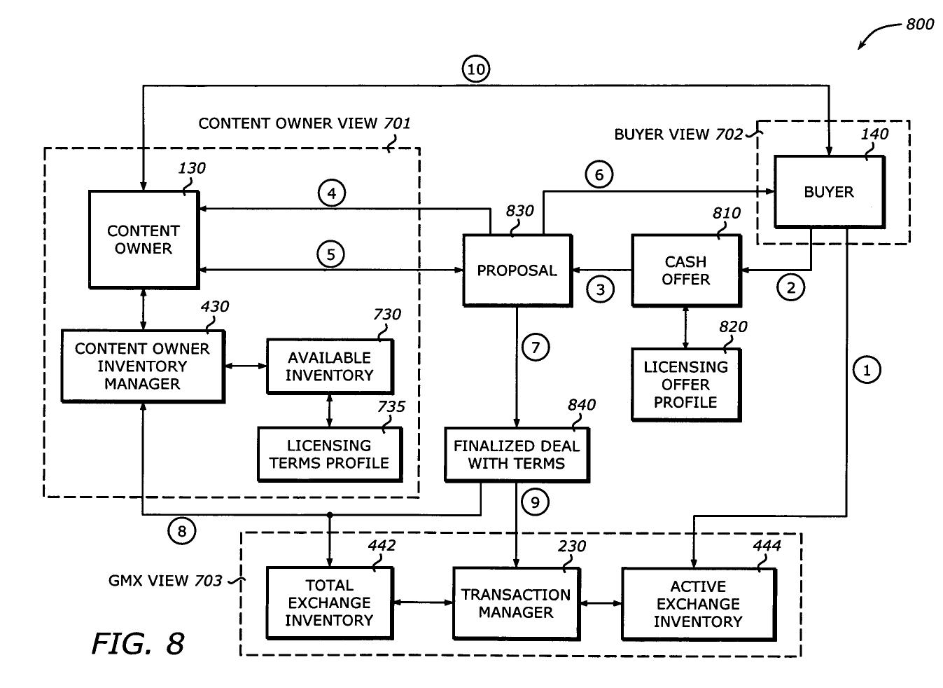

FIG. 8 is a diagram illustrating a cash deal transaction 800 according to one embodiment of the invention. The cash deal transaction 800 involves the content owner view 701, the buyer view 702, and the GMX view 703. The cash deal transaction 800 is illustrated by a sequence of actions shown as arrows. The numbers associated with the arrows indicate the actions as follows.

At action 1, the buyer 140 accesses the active exchange inventory 444. The buyer may invoke the inventory access module 340 (FIG. 3) to search and select an active inventory item. At action 2, the buyer 140 submits a cash offer 810 corresponding to the selected item from the active exchange inventory 444. At action 3, a proposal 830 is created from the cash offer 810. This may be performed by the proposal creator 610 (FIG. 6).

At action 4, the communication unit 620 (FIG. 6) forwards the proposal 830 to the content owner 130 or notifies the content owner 130 of the proposal 830. The content owner 130 may review the proposal 830. The content owner 130 then generates a response at action 5. The response may be an offer acceptance, an offer rejection, or an offer modification. At action 6, the communication unit 620 (FIG. 6) forwards the response from the content owner 130 to the buyer 140 or notifies the buyer 140 of the response. If the response is an offer rejection or an offer modification, the buyer 140 may submit a new cash offer and repeat action 2. If the response is an offer acceptance, the deal finalizer 630 (FIG. 6) then generates a finalized deal with terms 840 at action 7.

At action 8, the inventory manager 420 (FIG. 4) updates the content owner inventory 435, the total exchange inventory 442, and the active exchange inventory 444 with the inventory item with terms as finalized. At action 9, the deal finalizer 630 generates an entitlement to be granted or given to the exchange based on the transaction terms. The exchange transaction may then be concluded. At action 10, the financial settlement or any other actions may be performed outside of the exchange between the content owner 130 and the buyer 140.

In addition to the above transaction models, other models may be incorporated as supporting or complementing to the above transaction models. An example of such a model is a blind auction transaction model. This model is similar to a silent auction except that a bidder placing a bid does not know what the previous bids have been. The supporting or complementary model may be incorporated or combined with any of the above transaction models as appropriate. For example, a blind auction may take place among the participants to select the top N bidders. This blind auction may then be followed by a cash deal transaction among the selected N bidders.

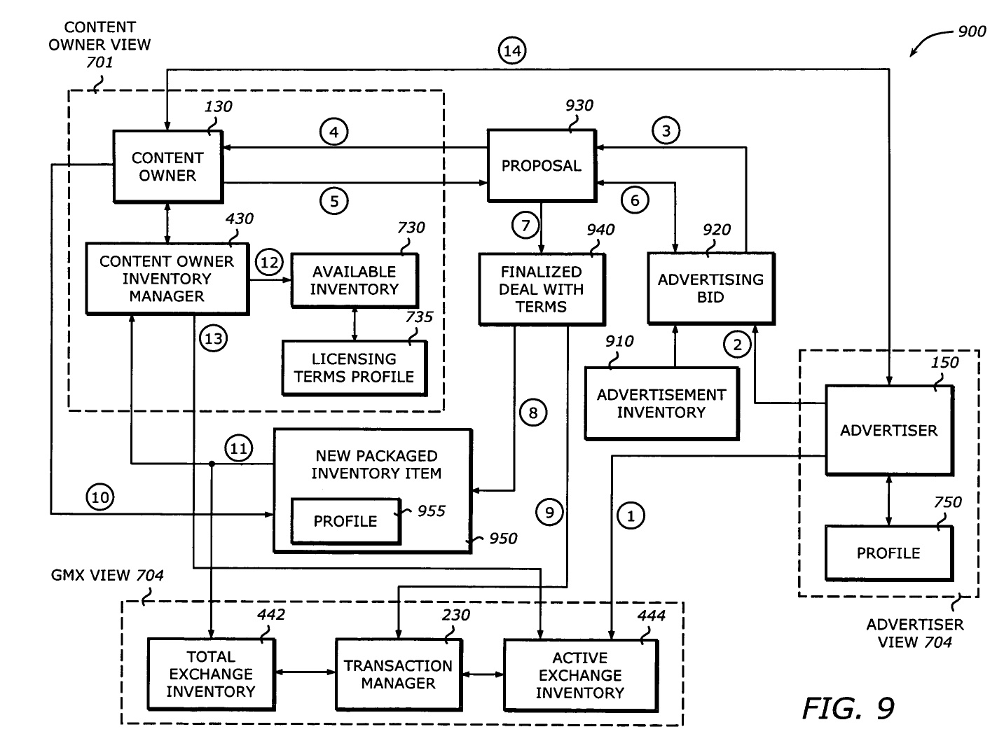

FIG. 9 is a diagram illustrating an advertisement transaction 900 according to one embodiment of the invention. The advertisement transaction 900 involves the content owner view 701, the advertiser view 704, and the GMX view 703. The advertisement transaction 900 is illustrated by a sequence of actions shown as arrows. The numbers associated with the arrows indicate the actions as follows.

At action 1, the advertiser 150 accesses the active exchange inventory 444. The advertiser 150 may invoke the inventory access module 340 (FIG. 3) to search, preview, and select an active inventory item. At action 2, the advertiser 150 submits an advertising bid 930 corresponding to the selected item from the active exchange inventory 444. The advertising bid 920 may be obtained from an advertisement inventory 910. At action 3, a proposal 930 is created from the advertising bid 920. This may be performed by the proposal creator 610 (FIG. 6).

At action 4, the communication unit 620 (FIG. 6) forwards the proposal 930 to the content owner 130 or notifies the content owner 130 of the proposal 930. The content owner 130 may review the proposal 930. The content owner 130 then generates a response at action 5. The response may be an offer acceptance, an offer rejection, or an offer modification. Alternatively, the content owner 130 may negotiate the deal terms by an offer modification. At action 6, the communication unit 620 (FIG. 6) forwards the response from the content owner 130 to the advertiser 150 or notifies the advertiser 150 of the response or the negotiated deal terms. If the response is an offer rejection, an offer modification, or a negotiated deal terms, the advertiser 150 may submit a new advertising bid 920 and repeat action 2. If the response is an offer acceptance, the deal finalizer 630 (FIG. 6) then generates a finalized deal with terms 940 at action 7.

At action 8, the inventory manager 420 (FIG. 4) creates a new packaged inventory item 950. At action 9, the deal finalizer 630 generates an entitlement to be granted or given to the exchange (e.g., the exchange/marketplace owner) based on the transaction terms. At action 10, the content owner 130 creates a packaged inventory profile 955 associated with the new packaged inventory item 950. At action 11, the inventory manager 420 (FIG. 4) updates the content owner inventory 435 and the total exchange inventory 442. At action 12, the content owner inventory manager 430 updates the available inventory 730. At action 13, the inventory manager 420 (FIG. 4) updates the active exchange inventory 444 with the new packaged inventory item and profile as created. The exchange transaction may then be concluded. At action 14, the financial settlement or any other actions may be performed outside of the exchange between the content owner 130 and the advertiser 150.

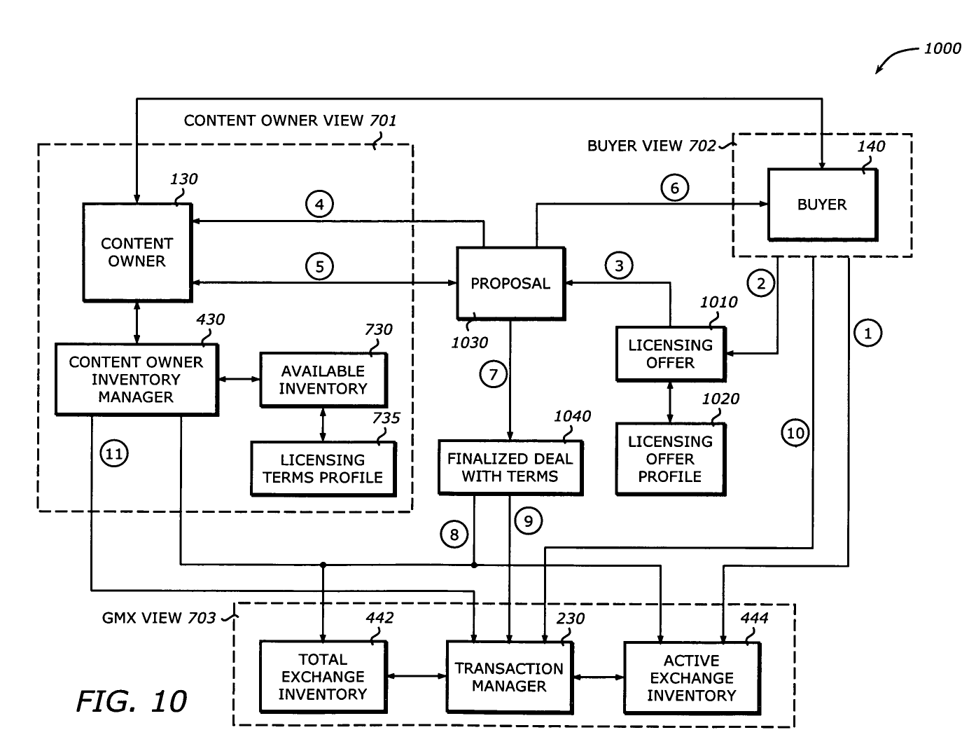

FIG. 10 is a diagram illustrating a revenue share transaction 1000 according to one embodiment of the invention. The revenue share transaction 1000 involves the content owner view 701, the buyer view 702, and the GMX view 703. The revenue share transaction 1000 is illustrated by a sequence of actions shown as arrows. The numbers associated with the arrows indicate the actions as follows.

At action 1, the buyer 140 accesses the active exchange inventory 444. The buyer may invoke the inventory access module 340 (FIG. 3) to search and select an active inventory item. At action 2, the buyer 140 submits a licensing offer 1010 corresponding to the selected item from the active exchange inventory 444. The licensing offer 1010 is associated with a licensing offer profile 1020. At action 3, a proposal 1030 is created from the licensing offer 1010. This may be performed by the proposal creator 610 (FIG. 6).

At action 4, the communication unit 620 (FIG. 6) forwards the proposal 1030 to the content owner 130 or notifies the content owner 130 of the proposal 1030. The content owner 130 may review the proposal 1030. The content owner 130 then generates a response at action 5. The response may be an offer acceptance, an offer rejection, or an offer modification. Alternatively, the content owner may negotiate deal terms through the offer modification. At action 6, the communication unit 620 (FIG. 6) forwards the response from the content owner 130 to the buyer 140 or notifies the buyer 140 of the response or the negotiated deal terms. If the response is an offer rejection, an offer modification, or negotiated deal terms, the buyer 140 may submit a new licensing offer and repeat action 2. If the response is an offer acceptance, the deal finalizer 630 (FIG. 6) then generates a finalized deal with terms 1040 at action 7.

At action 8, the inventory manager 420 (FIG. 4) updates the content owner inventory 435, the total exchange inventory 442, and the active exchange inventory 444 with the inventory item with terms as finalized. At action 9, the deal finalizer 630 generates an entitlement to be granted or given to the exchange based on the transaction terms. At action 10, the buyer 140 provides a full circle reporting for barter deal transactions. At action 11, the exchange provides full circle reporting for barter deal transactions to update the content owner inventory 435. The exchange transaction may then be concluded. At action 12, the financial settlement or any other actions may be performed outside of the exchange between the content owner 130 and the buyer 140.

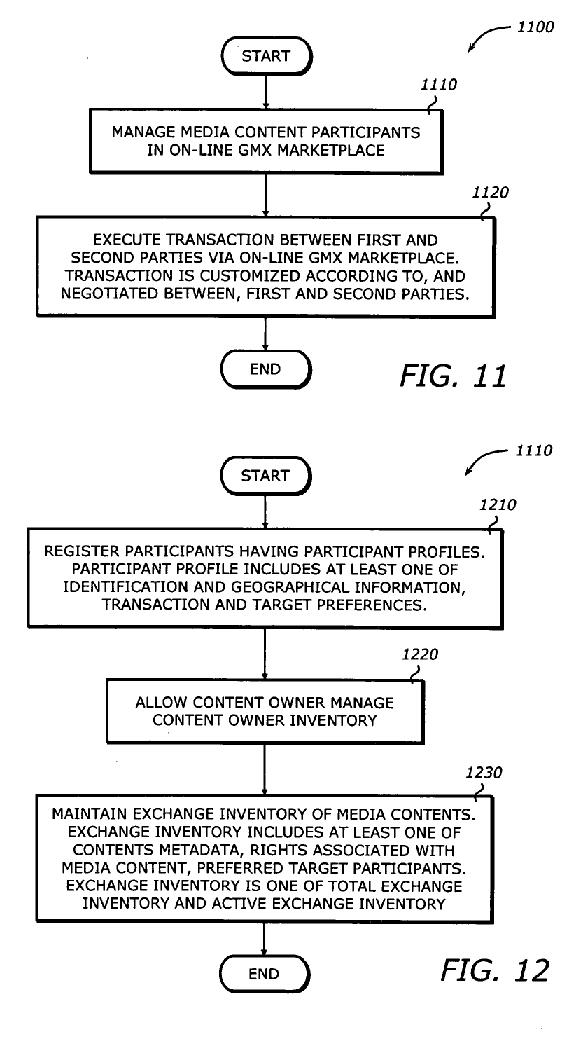

FIG. 11 is a flowchart illustrating a process 1100 to operate the marketplace according to one embodiment of the invention.

Upon START, the process 1100 manages media content participants in an on-line GMX marketplace (Block 1110). The participants include a first party and a second party. The first and second parties include at least one of a content owner, a buyer, an advertiser, and a third-party service provider.

Next, the process 1100 executes a transaction between the first and second parties via the on-line GMX marketplace (Block 1120). The transaction is customized according to, and negotiated between, the first and second parties. The process 1100 is then terminated.

FIG. 12 is a flowchart illustrating a process 1110 to manage participants according to one embodiment of the invention.

Upon START, the process 1110 registers the participants having participant profiles (Block 1210). Each of the participant profiles includes at least one of identification information, geographical information, transaction preferences, and target preferences.

Next, the process 1110 allows the content owner to manage a content owner inventory (Block 1220). This may include actions such as uploading the media content, updating the inventory with new packaged content, creating a profile associated with the new packaged content, removing the content, etc.

Then, the process 1110 maintains an exchange inventory of media contents (Block 1230). The exchange inventory includes at least one of content metadata, rights associated with the media content, and preferred target participants. The exchange inventory is one of a total exchange inventory and an active exchange inventory. The process 110 is then terminated.

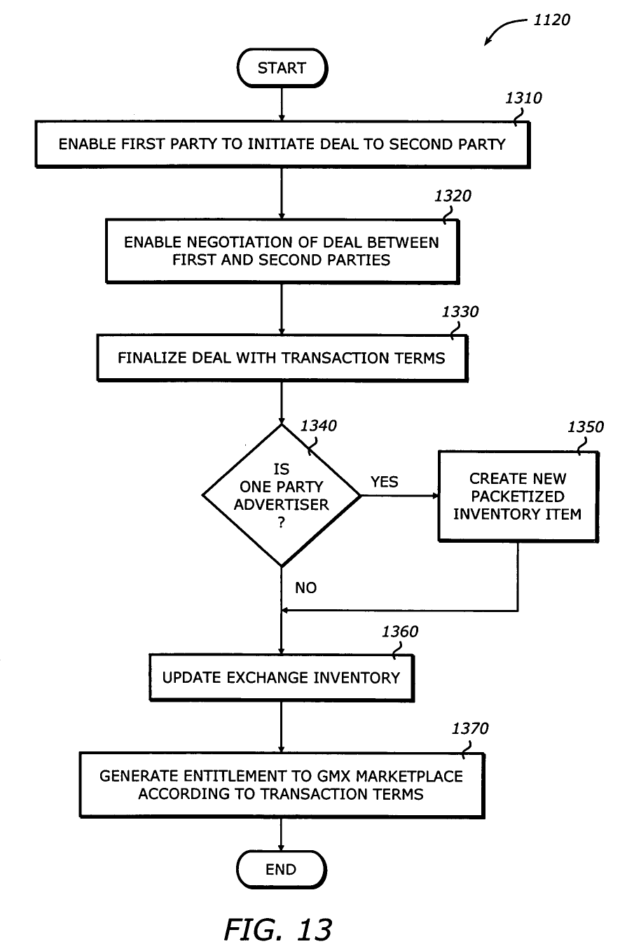

FIG. 13 is a flowchart illustrating the process 1120 shown in FIG. 11 to execute a transaction according to one embodiment of the invention.

Upon START, the process 1120 enables the first party to initiate a deal to the second party (Block 1310). Next, the process 1120 enables a negotiation of the deal between the first and second parties (Block 1320).

Then, the process 1120 finalizes the deal with transaction terms (Block 1330). The transaction terms may include any terms or conditions as finally agreed by both parties. This may also include any licensing terms, digital rights, or restriction agreements.

Next, the process 1120 determines if one of the parties is the advertiser (Block 1340). If so, the transaction is an advertising bid transaction. The process 1120 creates a new packaged inventory item (Block 1350) and goes to block 1360. Otherwise, the process 1120 updates the exchange inventory (Block 1360). This may include updating the content owner inventory, the total exchange inventory, and the active exchange inventory.

Then, the process 1120 generates an entitlement according to the transaction terms (Block 1370). The entitlement may be any right or benefit that is given to the exchange/marketplace owner as a compensation for providing the marketplace services. This may include a commission, a subscription, a flat fee, or any other suitable financial or commercial agreement. The commission may be paid to the exchange using any appropriate payment method. The process 1120 is then terminated.

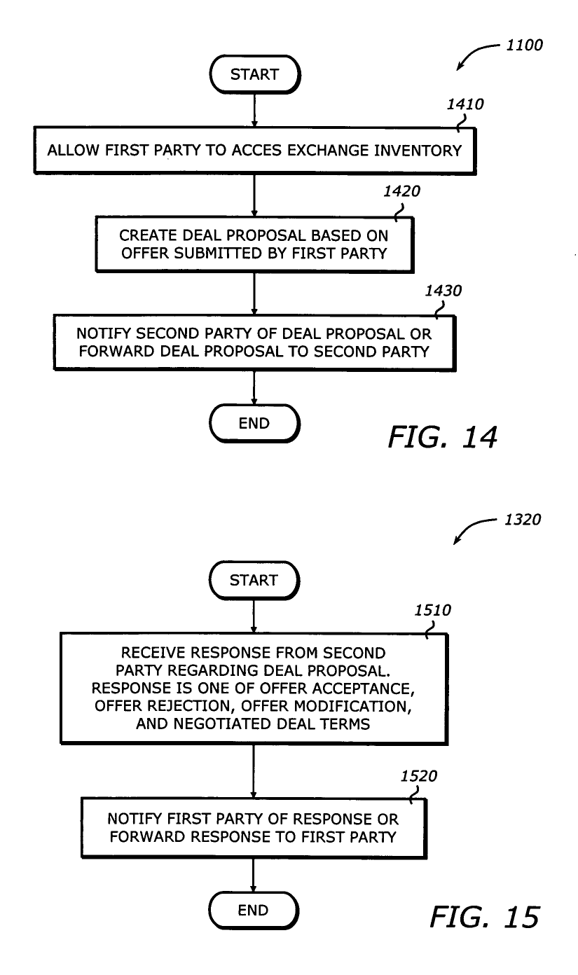

FIG. 14 is a flowchart illustrating the process 1310 shown in FIG. 13 to enable first party to initiate a deal according to one embodiment of the invention.

Upon START, the process 1310 allows the first party to access the exchange inventory (Block 1410). This may include allowing the first party to search and select an item from the active exchange inventory. For an advertising bid transaction, this may additionally include allowing the first party to preview the media content.

Next, the process 1310 creates a deal proposal based on an offer submitted by the first party (Block 1420). This may include any licensing terms associated with the selected item. Then, the process 1310 notifies the second party of the deal proposal or forwards the deal proposal to the second party for review (Block 1430). The deal proposal creation, the notification or the forwarding of the response may include security features such as encryption, digital signatures, or digital watermarking. The process 1310 is then terminated.

FIG. 15 is a flowchart illustrating the process 1320 shown in FIG. 13 to enable a negotiation according to one embodiment of the invention.

Upon START, the process 1320 receives a response from the second party regarding the deal proposal (Block 1510). The response includes one of an offer acceptance, an offer rejection, and an offer modification. The offer modification may represent negotiated deal terms. Next, the process 1320 notifies the first party of the response, or forwards the respond to the first party (Block 1520). The notification or the forwarding of the response may include security features such as encryption, digital signatures, or digital watermarking. The process 1320 is then terminated.

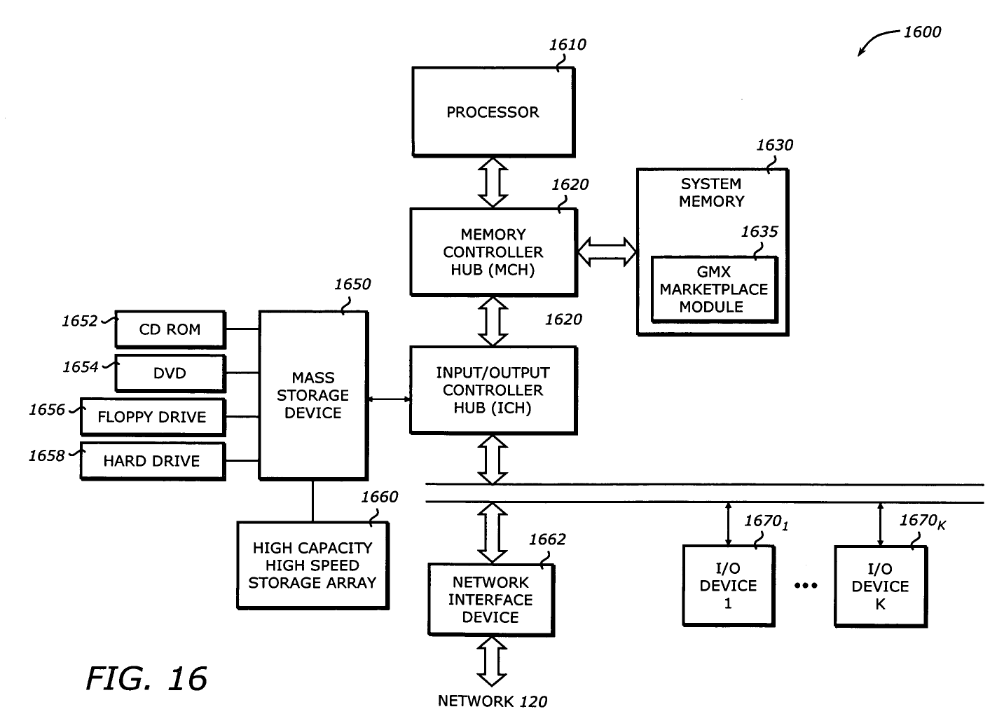

FIG. 16 is a diagram illustrating the server 110 shown in FIG. 1 according to one embodiment of the invention. The server 110 includes a processor unit 1610, a memory controller hub (MCH) 1620, a main memory 1630, an input/output controller hub (IOH) 1640, a mass storage device 1650, a network interface device 1662, and input/output (I/O) devices 1670₁ to 1670_{K}. It is noted that the server 1600 may contain more or less components than the above.

The processor unit 1610 represents a central processing unit of any type of architecture, such as processors using hyper threading, security, network, digital media technologies, single-core processors, multi-core processors, embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture.

The MCH 1620 provides control and configuration of memory and input/output devices such as the main memory 1630 and the ICH 1640. The MCH 1620 may be integrated into a chipset that integrates multiple functionalities such as graphics, media, host-to-peripheral bus interface, memory control, power management, etc. The MCH 1620 or the memory controller functionality in the MCH 1620 may be integrated in the processor unit 1610.

The main memory 1630 stores system code and data. The main memory 1630 is typically implemented with dynamic random access memory (DRAM), static random access memory (SRAM), or any other types of memories including those that do not need to be refreshed. The main memory 1630 may include a GMX marketplace module 1635. The GMX marketplace module 1635 may include instructions and/or data that perform any one of the tasks described above.

The ICH 1640 has a number of functionalities that are designed to support I/O functions. The ICH 1640 may also be integrated into a chipset together or separate from the MCH 1620 to perform I/O functions. The ICH 1640 may include a number of interface and I/O functions such as peripheral component interconnect (PCI) bus interface, processor interface, interrupt controller, direct memory access (DMA) controller, power management logic, timer, system management bus (SMBus), universal serial bus (USB) interface, mass storage interface, low pin count (LPC) interface, etc.

The mass storage device 1650 stores archive information such as code, programs, files, data, and applications. The mass storage device 1650 may include compact disk (CD) read-only memory (ROM) 1652, digital video/versatile disc (DVD) 1654, floppy drive 1656, and hard drive 1658, and any other magnetic or optic storage devices. The mass storage device 1650 provides a mechanism to read machine-accessible media embedded in an article of manufacture. The machine-accessible media may include data that, when accessed by a machine, cause the machine to perform any one of the tasks or operations described above. In addition, the mass storage device 1650 may include high-capacity high speed storage arrays 1660 to store media contents, BI repository, exchange inventories, such as Redudant Array of Inexpensive Disks (RAIDs), Network Attached Storage (NAS), digital tapes, optical storage, etc.

The network interface device 1662 provides interface to the network 120 (FIG. 1), or any other wired or wireless interconnecting medium to communicate with other units or servers. It may be any suitable network interface card (NIC) or satellite receiver card. It may also provide interfaces to Asynchronous Transfer Mode (ATM), Synchronous Optical Networking (SONET), Gigabit Ethernet, cable network, satellite, etc.

The I/O devices 1670₁ to 1670_{K} may include any I/O devices to perform I/O functions. Examples of I/O devices 1670₁ to 1670_{K} include controller for input devices (e.g., keyboard, mouse, trackball, pointing device), media card (e.g., audio, video, graphics), and any other peripheral controllers.

Elements of embodiments of the invention may be implemented by hardware, firmware, software or any combination thereof. The term hardware generally refers to an element having a physical structure such as electronic, electromagnetic, optical, electro-optical, mechanical, electromechanical parts, components, or devices, etc. The term software generally refers to a logical structure, a method, a procedure, a program, a routine, a process, an algorithm, a formula, a function, an expression, etc. The term firmware generally refers to a logical structure, a method, a procedure, a program, a routine, a process, an algorithm, a formula, a function, an expression, etc., that is implemented or embodied in a hardware structure (e.g., flash memory). Examples of firmware may include microcode, writable control store, micro-programmed structure. When implemented in software or firmware, the elements of an embodiment of the present invention are essentially the code segments to perform the necessary tasks. The software/firmware may include the actual code to carry out the operations described in one embodiment of the invention, or code that emulates or simulates the operations. The program or code segments can be stored in a processor or machine accessible medium or transmitted by a computer data signal embodied in a carrier wave, or a signal modulated by a carrier, over a transmission medium. The “processor readable or accessible medium” or “machine readable or accessible medium” may include any medium that can store, transmit, or transfer information. Examples of the processor readable or machine accessible medium include an electronic circuit, a semiconductor memory device, a read only memory (ROM), a flash memory, an erasable ROM (EROM), an erasable programmable ROM (EPROM), a floppy diskette, a compact disk (CD) ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. The machine accessible medium may be embodied in an article of manufacture. The machine accessible medium may include data that, when accessed by a machine, cause the machine to perform the operations described in the following. The machine accessible medium may also include program code embedded therein. The program code may include machine readable code to perform the operations described in the following. The term “data” here refers to any type of information that is encoded for machine-readable purposes. Therefore, it may include program, code, data, file, etc.

All or part of an embodiment of the invention may be implemented by hardware, software, or firmware, or any combination thereof. The hardware, software, or firmware element may have several modules coupled to one another. A hardware module is coupled to another module by mechanical, electrical, optical, electromagnetic or any physical connections. A software module is coupled to another module by a function, procedure, method, subprogram, or subroutine call, a jump, a link, a parameter, variable, and argument passing, a function return, etc. A software module is coupled to another module to receive variables, parameters, arguments, pointers, etc. and/or to generate or pass results, updated variables, pointers, etc. A firmware module is coupled to another module by any combination of hardware and software coupling methods above. A hardware, software, or firmware module may be coupled to any one of another hardware, software, or firmware module. A module may also be a software driver or interface to interact with the operating system running on the platform. A module may also be a hardware driver to configure, set up, initialize, send and receive data to and from a hardware device. An apparatus may include any combination of hardware, software, and firmware modules.

One embodiment of the invention may be described as a process, which is usually depicted as a flowchart, a flow diagram, a structure diagram, or a block diagram. Although a flowchart may describe the operations as a sequential process, many of the operations can be performed in parallel or concurrently. A loop or iterations in a flowchart may be described by a single iteration. It is understood that a loop index or loop indices or counter or counters are maintained to update the associated counters or pointers. In addition, the order of the operations may be re-arranged. A process terminates when its operations are completed. A process may correspond to a method, a program, a procedure, etc. A block diagram may contain blocks or modules that describe an element, an item, a component, a device, a unit, a subunit, a structure, a method, a process, a function, an operation, a functionality, or a task, etc. A functionality or an operation may be performed automatically or manually.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. A method comprising:
managing media content participants in an on-line global media exchange (GMX) marketplace, the participants including a first party and a second party, the first and second parties including at least one of a content owner, a buyer, an advertiser, and a third-party service provider; and
executing a transaction between the first and second parties via the on-line GMX marketplace, the transaction being customized according to, and negotiated between, the first and second parties.

2. The method of claim 1 wherein managing the participants comprises:
registering the participants having participant profiles, each of the participant profiles including at least one of identification information, geographical information, transaction preferences, and target preferences;
allowing the content owner to manage a content owner inventory; and
maintaining an exchange inventory of media contents, the exchange inventory including at least one of content metadata, rights associated with the media content, and preferred target participants, the exchange inventory being one of a total exchange inventory and an active exchange inventory.

3. The method of claim 2 wherein executing the transaction comprises:
enabling the first party to initiate a deal to the second party; and
enabling a negotiation of the deal between the first and second parties.

4. The method of claim 3 wherein enabling the first party to initiate the deal comprises:
allowing the first party to access the exchange inventory;
creating a deal proposal based on an offer submitted by the first party; and
notifying the second party of the deal proposal.

5. The method of claim 4 wherein enabling the negotiation comprises:
receiving a response from the second party regarding the deal proposal, the response including one of an offer acceptance, an offer rejection, and an offer modification; and
notifying the first party of the response.

6. The method of claim 5 wherein executing the transaction further comprises:
finalizing the deal with transaction terms;
creating a new packaged inventory item if one of the first and second parties is the advertiser; and
updating the exchange inventory.

7. The method of claim 6 wherein executing the transaction further comprises:
generating an entitlement according to the transaction terms.

8. The method of claim 4 wherein creating the deal proposal comprises:
creating the deal proposal according to the offer being one of a cash offer, an advertising bid, and a revenue share bid; and
incorporating licensing profile into the deal proposal when the offer is the cash offer or the revenue share bid.

9. The method of claim 4 wherein maintaining the exchange inventory of media contents comprises:
creating the active exchange inventory from the total exchange inventory.

10. The method of claim 9 wherein allowing the first party to access the exchange inventory comprises:
allowing the first party to perform an access action on the active exchange inventory, the access action being one of a search, a preview, and a selection.

11. An article of manufacture comprising:
a machine-accessible medium including data that, when accessed by a machine, cause the machine to perform operations comprising:
managing media content participants in an on-line global media exchange (GMX) marketplace, the participants including a first party and a second party, the first and second parties including at least one of a content owner, a buyer, an advertiser, and a third-party service provider; and
executing a transaction between the first and second parties via the on-line GMX marketplace, the transaction being customized according to, and negotiated between, the first and second parties.

12. The article of manufacture of claim 11 wherein the data causing the machine to perform managing the participants comprises data that, when accessed by a machine, cause the machine to perform operations comprising:
registering the participants having participant profiles, each of the participant profiles including at least one of participant identification information, geographical information, transaction preferences, and target preferences;
allowing the content owner to manage a content owner inventory; and
maintaining an exchange inventory of media contents, the exchange inventory including at least one of content metadata, rights associated with the media content, and preferred target participants, the exchange inventory being one of a total exchange inventory and an active exchange inventory.

13. The article of manufacture of claim 12 wherein the data causing the machine to perform executing the transaction comprises data that, when accessed by a machine, cause the machine to perform operations comprising:
enabling the first party to initiate a deal to the second party; and
enabling a negotiation of the deal between the first and second parties.

14. The article of manufacture of claim 13 wherein the data causing the machine to perform enabling the first party to initiate a deal to the second party comprises data that, when accessed by a machine, cause the machine to perform operations comprising:
allowing the first party to access the exchange inventory;
creating a deal proposal based on an offer submitted by the first party; and
notifying the second party of the deal proposal.

15. The article of manufacture of claim 11 wherein the data causing the machine to perform enabling the negotiation of the deal comprises data that, when accessed by a machine, cause the machine to perform operations comprising:
receiving a response from the second party regarding the deal proposal, the response including one of an offer acceptance, an offer rejection, and an offer modification; and
notifying the first party of the response.

16. The article of manufacture of claim 15 wherein the data causing the machine to perform executing the transaction further comprises data that, when accessed by a machine, cause the machine to perform operations comprising:
finalizing the deal with transaction terms;
creating a new packaged inventory item if one of the first and second parties is the advertiser; and
updating the exchange inventory.

17. The article of manufacture of claim 16 wherein the data causing the machine to perform executing the transaction further comprises data that, when accessed by a machine, cause the machine to perform operations comprising:
generating an entitlement according to the transaction terms.

18. The article of manufacture of claim 14 wherein the data causing the machine to perform creating the deal proposal comprises data that, when accessed by a machine, cause the machine to perform operations comprising:
creating the deal proposal according to the offer being one of a cash offer, an advertising bid, and a revenue share bid; and
incorporating licensing profile into the deal proposal when the offer is the cash offer or the revenue share bid.

19. The article of manufacture of claim 14 wherein the data causing the machine to perform maintaining the exchange inventory comprises data that, when accessed by a machine, cause the machine to perform operations comprising:
creating the active exchange inventory from the total exchange inventory.

20. The article of manufacture of claim 19 wherein the data causing the machine to perform allowing the first party to access the exchange inventory comprises data that, when accessed by a machine, cause the machine to perform operations comprising:
allowing the first party to perform an access action on the active exchange inventory, the access action being one of a search, a preview, and a selection.

21. A marketplace comprising:
a user interface module to interface with media content participants in an on-line global media exchange (GMX) marketplace, the participants including a first party and a second party, the first and second parties including at least one of a content owner, a buyer, an advertiser, and a third-party service provider;
a participant manager coupled to the user interface module to manage the media content participants; and
a transaction manager coupled to the user interface module and the participant manager to execute a transaction between the first and second parties.

22. The marketplace of claim 21 wherein the user interface module comprises:
an administration front end module to administer interactions between the GMX marketplace and the participants; and
a services module to provide on-line services to the participants, the services module including at least one of an application programming interface (API), an inventory access module, a participant configuration module, and a transaction tool module.

23. The marketplace of claim 21 wherein the participant manager comprises:
a business intelligence (BI) repository to store business information regarding the participants;
an inventory manager to manage inventories of media contents, the inventories including at least one of a content owner inventory, a total exchange inventory, and an active exchange inventory;
a participant registry to maintain registration information on the participants; and
an interoperability manager to maintain interoperability among the participants.

24. The marketplace of claim 21 wherein the transaction manager comprises:
a component manager to manage a component of the GMX marketplace, the component including at least one of a business-to-business (B2B) information gateway, a content management application, an electronic commerce (e-Commerce) application, a customer relationship management (CRM) application, a BI engine, a back office application, a services fulfillment application, an asset licensing application, and a rights management application; and
an execution engine coupled to the component manager to enable and fulfill the transaction.

25. The marketplace of claim 24 wherein the execution engine enables the first party to initiate a deal to the second party and enables a negotiation of the deal between the first and second parties.

26. The marketplace of claim 25 wherein the execution engine comprises:
a proposal creator to create a deal proposal based on an offer submitted by the first party, the offer being one of a cash offer, an advertising bid, and a revenue share bid, the proposal creator incorporating licensing profile into the deal proposal when the offer is the cash offer or the revenue share bid; and
a communication unit to forward the deal proposal to the second party and to forward a response from the second party to the first party, the response including one of an offer acceptance, an offer rejection, and an offer modification; and
a deal finalizer to finalize the deal with transaction terms.

27. The marketplace of claim 25 wherein inventory manager comprises:
a content owner inventory manager to manage the content owner inventory; and
an exchange inventory manager to manage the exchange inventory, the exchange inventory manager updating the exchange inventory after the deal is finalized.

28. The marketplace of claim 21 further comprising:
a portal engine to provide a centralized access point for the GMX marketplace.

29. The marketplace of claim 26 wherein the deal finalizer generates an entitlement according to the transaction terms.

30. The marketplace of claim 22 wherein the inventory access module allows the first party to perform an access action on the active exchange inventory, the access action being one of a search, a preview, and a selection.
